(19) United States
(12) Patent Application Publication
(10) Pub. No.: US 2006/0187151 A1
(43) Pub. Date: Aug. 24, 2006

(54) Display device

(76) Inventors: Yoshihisa Ooishi, Yokohama (JP); Toshifumi Ozaki, Koganei (JP); Fumio Haruna, Yokohama (JP); Toshimitsu Watanabe, Yokohama (JP); Yoshiro Mikami, Hitachiota (JP)

Correspondence Address: MILBANK, TWEED, HADLEY & MCCLOY, 1 CHASE MANHATTAN PLAZA, NEW YORK, NY, 10005-1413, US

(21) Appl. No.: 11/301,936

(22) Filed: Dec. 13, 2005

(30) Foreign Application Priority Data
Dec. 16, 2004 (JP) 2004-364192

(51) Int. Cl. G09G 3/20

(52) U.S. Cl. 345/74.1

(57) ABSTRACT

Input display data (D0, D1, D2) are converted into currents ij which are allowed to flow into respective pixels by a data/current conversion part 66, electric currents IN at end portions of a row wiring are calculated by a current IN calculation circuit 68-2 using the currents ij, and a voltage drop VN at an end portion of the row wiring is calculated by a voltage drop VN calculation circuit 68-4 using the current IN. On the other hand, the sum of the currents ij is calculated by a current ij calculation circuit 68-6, and a current Im−1 which flows between the pixels is calculated by a current Im−1 calculation circuit 68-7 using the sum of the currents ij and the currents IN. Next, using a currents Ij between the respective pixels and the voltage drops VN calculated by a current Ij calculation circuit 68-8, a voltage drop Vm−1 is calculated by a voltage drop Vm−1 calculation circuit 68-9, and the voltage drop Vm−1 is converted into the data by the voltage/data conversion part 67, and the data and the input display data are added to each other in an adding circuit 64 so as to obtain the output display data (D0, D1, D2) which are corrected by an amount corresponding to the voltage drop.

### CLAIM OF PRIORITY

The present application claims priority from Japanese application serial No. 2004-364192, filed on Dec. 16, 2004, the content of which is hereby incorporated by reference into this application.

### BACKGROUND OF THE INVENTION

1. Field of the Invention

The present invention relates to a display device which is capable of correcting a voltage drop in a scanning line (row wiring) which is driven from both ends thereof, and more particularly to a display device which uses MIM type electron emission elements.

2. Description of the Related Art

Heretofore, as a cold cathode electron emission element, there has been known a metal/insulation/metal type electron emission element (hereinafter referred to as “MIM type electron emission element”), for example. The MIM type electron emission element emits electrons from a surface of the electrode when a voltage is applied to upper and lower electrodes which sandwich an insulation layer therebetween.

In this MIM type electron emission element, approximately 95% of electrons which are emitted from the lower electrode are not emitted as electrons and flow in the upper electrode. Accordingly, in the display device which uses a plurality of elements, a voltage drop is generated in row wiring which is connected to the upper electrode thus generating brightness irregularities. There may be a case in which such a phenomenon occurs also with respect to other cold cathode emission element. Accordingly, a system which can correct a column-wiring voltage for preventing such a phenomenon has been studied.

Japanese Patent 3311201 (see patent document 1) discloses a method in which, for correcting a voltage drop at respective portions of selected row wirings which are determined corresponding to an image pattern to be displayed, a corrected drive pulse is outputted to the respective column wiring.

Further, JP-A-2002-229506 (patent document 2) discloses a method in which, in an image display device which simultaneously drives a plurality of cold cathode elements which are connected by one row wiring, a voltage drop quantity of a row wiring is calculated and an image signal is corrected based on the voltage drop quantity.

### SUMMARY OF THE INVENTION

In patent document 1, a scanning circuit is arranged only on one side of the row wiring. That is, in patent document 1, a method which performs the voltage correction using column wirings in driving the display device with scanning circuits which are arranged on both sides of the row wiring is not taken into consideration. Further, in patent literature 2, although the scanning circuits are arranged on both sides of the row wiring, when an approximation model is not used, with respect to a display panel which includes N lines of column wirings, it is necessary to perform the sum of products operation of N×N within one horizontal scanning period N times and hence, a large-scale hardware becomes necessary.

Accordingly, it is an object of the invention to perform the voltage correction of high accuracy without using a large-scale hardware when the driving is performed using scanning circuits which are arranged on both sides of the row wiring.

When the scanning circuits are arranged on both sides of the row wiring, a total current which flows in one end-portion pixel of the row wiring from a ground point is obtained by superposing a component which flows in from one end portion out of an electric current which flows into the column wiring from the row wiring of respective pixels, and a voltage drop at the pixels at end portions are obtained by applying the resistance from a ground point to pixels at both ends to the total current.

Subsequently, the current which flows from the row wiring to the column wiring in the mth pixel from the end portion is sequentially added, a current which flows between the neighboring pixels is obtained by subtracting the current from the total current, an added value of the voltage drop of the neighboring pixel which is obtained by multiplying a resistance value per one pixel to a value to which the current between neighboring pixels is sequentially added from the end portion to the mth pixel is calculated based on the voltage drops at pixels at the end portions thus obtaining the voltage drops generated in the respective pixels.

According to the invention, the sum of products operation within one horizontal scanning period is constituted of the N×N sum-of-products operation for calculating a diode current IN and an accumulation calculation of N pieces of 1×1 for calculating the voltage drop (Vm−1). Accordingly, although the N×N sum-of-products operation is performed N times conventionally, according to the invention, the sum-of-products operation can be remarkably reduced to 1/N times. Further, since the number of sum-of-products operation is reduced, the control can be realized by a simple hardware.

### BRIEF DESCRIPTION OF THE DRAWINGS

FIG. 1 is a whole constitutional view according to the invention;

FIG. 2 is a constitutional view of a data driver in a modulation circuit shown in FIG. 1;

FIG. 3 is a constitutional view of a scanning driver in a scanning circuit shown in FIG. 1;

FIG. 4 is a driving timing chart of the data driver and the scanning driver shown in FIG. 2 and FIG. 3;

FIG. 5 is an equivalent circuit diagram of a row wiring shown in FIG. 1;

FIG. 6 is a voltage drop correction circuit diagram mounted in the inside of a display controller shown in FIG. 1;

FIG. 7 is another voltage drop correction circuit diagram mounted in the inside of a display controller shown in FIG. 1; and

FIG. 8 is another whole constitutional view according to the invention.

### DESCRIPTION OF THE PREFERRED EMBODIMENTS

Hereinafter, embodiments of the invention are explained in conjunction with attached drawings.

### Embodiment 1

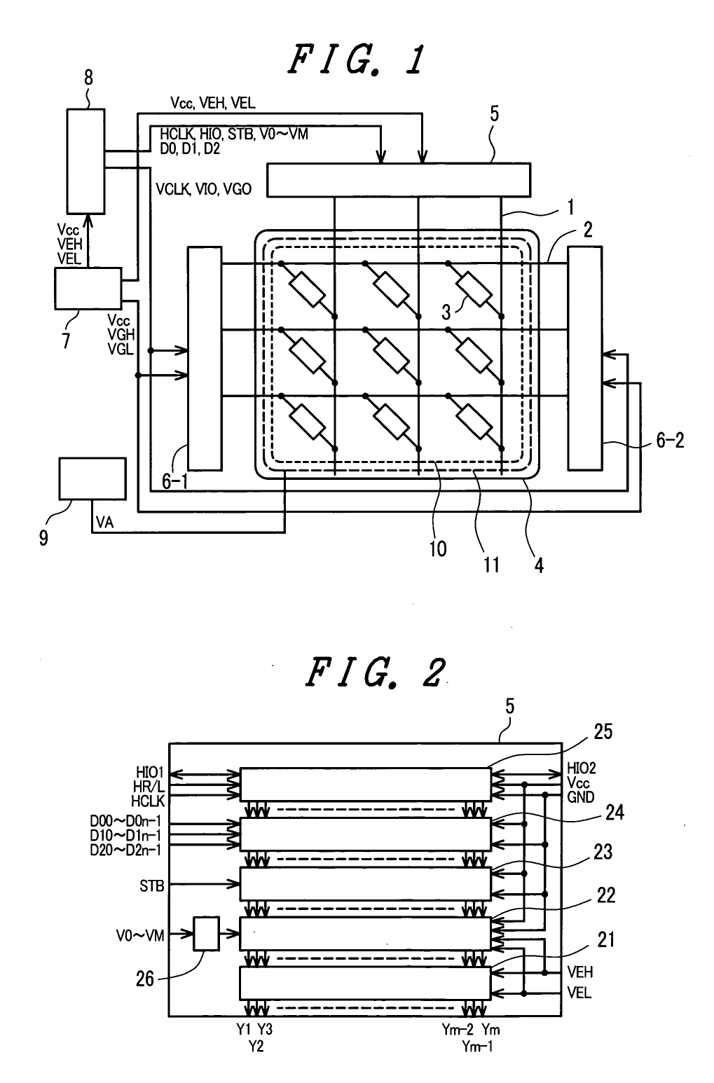

FIG. 1 is a whole constitutional view according to the invention, wherein a display panel 4 is constituted of column wirings 1, row wirings 2, a back plate which includes MIM type electron emission elements 3, a face plate which includes a phosphor film 10 and a metal back 11 which is formed to cover the phosphor film 10 on a surface thereof which faces the back plate, and a side wall which is formed around a periphery of the display panel 4 for evacuating the inside of the display panel 4 where a pixel is formed together with the back plate and the face plate. The phosphor film 10 is constituted of three primary colors of red, green and blue which are separately colored for every columns of the MIM type electron emission elements 3.

A modulation circuit 5 outputs a modulation signal to the column wirings 1. Scanning circuits 6-1, 6-2 are arranged on both sides of the display panel 4 so as to perform the row selection.

A driver power source 7 supplies a selection voltage VGH, a non-selection voltage VGL and a logic circuit voltage Vcc to the scanning circuits 6-1, 6-2. Further, the driver power source 7 supplies a light emitting voltage VEL, a non-light-emitting voltage VEH and a logic circuit voltage Vcc to the modulation circuit 5 and the display controller 8.

The display controller 8 outputs a vertical clock VCLK, a start pulse VIO and a selection period signal VGO to the scanning circuits 6-1, 6-2. Further, the display controller 8 outputs a horizontal clock HCLK, a start pulse HIO, an output changeover signal STB, the 3-output display data D0, D1, D2 of n bits corresponding to red, green, blue and reference voltages V0 to VM to the modulation circuit 5.

Among these control signals, all signals except for the reference voltages V0 to VM have an amplitude of the logic circuit voltage Vcc.

Further, an anode power source 9 supplies an anode voltage VA for allowing the phosphor film 10 to emit light to the metal back 11.

The modulation circuit 5 is constituted of a data driver shown in FIG. 2. The data drivers are connected in series when necessary.

In FIG. 2, numeral 25 indicates a shift register which generates a latch signal for fetching the display data, numeral 24 indicates a data register which sequentially fetches 3-output display data D00 to Don-1, D10 to D1n-1, D20 to D2n-1 of n bits corresponding to red, green and blue which are simultaneously imputed from the display controller, numeral 23 indicates a data latch which fetches the display data of data register in synchronism with an output changeover signal STB, numeral 26 indicates a gray scale voltage generating part which generates scale voltages of n-powers of 2 from reference voltages V0 to VM which the display roller 8 outputs based on resistance division, numeral 22 indicates a decoder which selects a voltage from the gray scale voltages of n-power of 2 corresponding to display data of n bits which the data latch outputs, and numeral 21 indicates an output circuit which is constituted of voltage followers for outputting decoder output voltages as output voltages Y1 to Ym to respective column wirings 1 of the display panel 4. Here, the linear relationship is set between the gray scales and the output voltages.

Symbol HR/L indicates a signal for determining the shift direction of the shift register and is fixed to the logic circuit voltage Vcc or a ground voltage GND.

Here, when one horizontal scanning period is started, the inside of the shift register 25 into which the start pulse HIO is inputted as the signal HI01 (or HI02) of the first data driver is shifted in synchronism with the horizontal clock HCLK, while when the latch signal is outputted, the display data of n bits is sequentially fetched into the data register 24 simultaneously with respect to three outputs.

When the fetching of display data into the data register 24 of the first data driver is finished, the voltage of the signal HI02 (or HI01) becomes the logic circuit voltage Vcc. When necessary, the signal HI02 (or HI01) is added to the signal HI01 (or HI02) of the second data driver (not shown in the drawing) and the fetching of the display data of the second data driver is started.

When the fetching of all display data into the data register 24 is finished in this manner, immediately before one horizontal scanning period, all display data is fetched into the data latch 23 from the data register 24 in synchronism with the output changeover signal STB.

The fetched data is converted into the gray scale voltages respectively by the decoder 22 and the gray scale voltages are outputted to the respective column wirings by the output circuit 21.

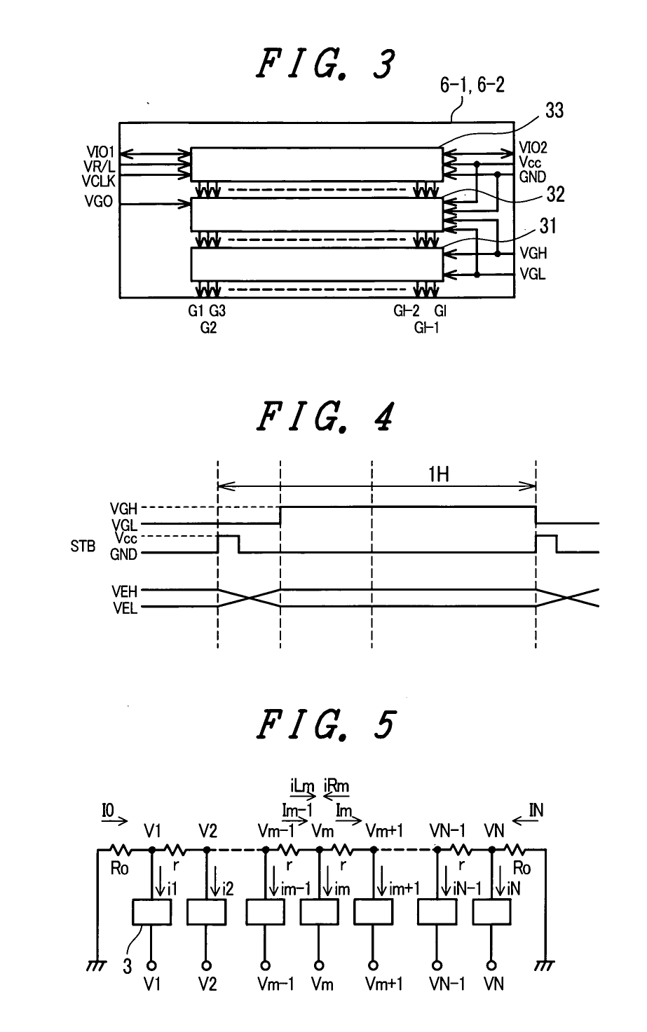

The scanning circuits 6-1, 6-2 shown in FIG. 1 are formed of a scanning driver shown in FIG. 3. The scanning drivers are connected in series when necessary.

In FIG. 3, numeral 33 indicates a shift register which generates a selection signal for sequentially changing over the selected rows for every one horizontal scanning period, numeral 32 indicates a level shifter which converts an output from the shift register 33 from a level of a logic circuit voltage Vcc-GND to a level of selection voltage VGH—non-selection voltage VGL, and numeral 31 indicates an output circuit which is constituted of a CMOS inversion circuit for outputting the selection voltage VGH or the non-selection voltage VGL as the output voltages G1 to GI to the respective row wirings 2 of the display panel 4 in response to the level-shifted output. Symbol VR/L indicates a signal for determining the shift direction of the shift register and is fixed to the logic circuit voltage Vcc or the ground voltage GND.

Here, when one vertical scanning period is started, the start pulse VIO is inputted as the first scanning driver signal VIO1 (or VIO2), and the inside of the shift register 33 is shifted in synchronism with the vertical clock VCLK for every one horizontal scanning period and the selection signal is sequentially outputted.

A logic product of the outputted selection signal and the selection period signal VGO has a level thereof shifted by the level shifter 32, and the selection voltage VGH is outputted to the selected row wiring of the display panel 4 from the output circuit 31, while the non-selection voltage VGL is outputted to the non-selected row wiring of the display panel 4.

When the shift inside the first scanning driver is finished, the voltage of the signal VIO2 (or VI01) becomes the logic circuit voltage Vcc, the voltage of the signal VI02 (or VI01) is added to the signal VIO1 (or VIO2) of the second scanning driver (not shown in the drawing) when necessary, and the shift in the inside of the second scanning driver is started. In this manner, all rows are sequentially selected.

FIG. 4 shows the timing of the data drive output within one horizontal scanning period 1H, wherein the data driver output is changed over in synchronism with the output changeover signal STB. The scanning driver output is changed from the non-selection voltage VGL to the selection voltage VGH after a lapse of a delay time which is determined based on the resistance and the capacity of the row wiring and the output impedance of the data driver.

At a point of time that one horizontal scanning period finishes, an output of the scanning driver is changed from the selection voltage VGH to the non-selection voltage VGL and, at the same time, the output of the data driver is changed over.

When the current flows in the row wirings, the resistance of the row wirings is set to a low value to prevent the voltage drop and a time constant of the row wirings is set smaller than a time constant of the column wiring.

With respect to the timing adopted in this embodiment, the light emitting time is determined by the output time of the scanning driver which outputs the signal to the row wirings having the small wiring time constant. As a result, it is possible to reduce the non-uniformity of the brightness generated by the wiring delay.

FIG. 5 is an equivalent circuit diagram for explaining the manner of row wiring voltage drop and the correction when the scanning circuits are arranged at both sides. Numeral 3 indicates MIM type electron emission elements, symbol r indicates the scanning line resistance per one pixel, symbol Ro indicates the resistance from the ground point to the pixels at both ends, symbol im indicates a diode current of the mth pixel, symbol iRm indicates a component of the diode current im of the mth pixel which flows in from right, symbol iLm indicates a component of the diode current im of the mth pixel which flows in from left, symbol Vm indicates a row-wiring voltage drop which is generated in the mth pixel, symbol Im indicates a current which flows into the (m+1)th pixel from the mth pixel.

To set the diode current im which flows in the respective pixels of the MIM type electron emission elements 3 to a given value, to the output of the data driver outputted to the mth pixel, the voltage which is lowered by the row-wiring voltage drop Vm generated in the mth pixel is outputted.

The row wiring voltage drop generated in the mth pixel is obtained as follows.

The diode current im of the mth pixel is constituted of two components, that is, iLm and iRm which flow in the pixel from the scanning circuits from both sides.

Assuming the voltage drop generated in the mth pixel as vm when the diode current flows in only the mth pixel, since the voltage drops to the ground points at both ends are equal, a following formula (1) is established.
vm=−{(m−1)r+R₀}iLM=−{(N−m)+R₀}iRM (1)

The component iLm of the diode current im is obtained by a following formula (2) by taking iRm=im−iLm into consideration.

$$iLm = \frac{( N - m ) r + {R}_{0}}{( N - 1 ) r + 2 {R}_{0}} im \qquad ( 2 )$$

Further, the component iRm of the diode current im is obtained by a following formula (3).

$$iRm = \frac{( m - 1 ) r + {R}_{0}}{( N - 1 ) r + 2 {R}_{0}} im \qquad ( 3 )$$

The current IN which flows in the Nth pixel at the right end from the ground point is expressed by a following formula (4) by adding the component iRm of the diode current im of the mth pixel which flows in the pixel from right expressed by the formula (3) based on the principle of the superposition.

$$IN = {\sum }_{j = 1}^{N} iRj = {\sum }_{j = 1}^{N} \frac{( j - 1 ) r + {R}_{0}}{( N - 1 ) r + 2 {R}_{0}} ij \qquad ( 4 )$$

To multiply the resistance Ro from the ground point to the pixels at both ends to the current IN, the voltage drop VN of the Nth pixel is obtained by a following formula (5).
VN=−R₀×IN (5)

Further, the current Im−1 which flows in the mth pixel from the (m−1)th pixel due to the current preservation law in the mth pixel is a value obtained by adding the diode current im of the mth pixel to the current Im which flows in the (m+1)th pixel from the mth pixel. The similar relationship is established from the (m+1)th pixel to the Nth pixel and hence, a following formula (6) is established.

$$Im - 1 = Im + im = - ( IN - {\sum }_{j = m}^{N} ij ) \qquad ( 6 )$$

Further, the voltage drop Vm−1 which is generated in the (m−1) th pixel is a value which is obtained by adding the voltage drop between the neighboring pixels to the Vm, wherein the voltage drop is obtained by multiplying the resistance value r per one pixel to the current Im−1. The similar relationship is established from the mth pixel to the Nth pixel and hence, a following formula (7) is established.

$$Vm - 1 = Vm + rIm - 1 = VN + r {\sum }_{j = m - 1}^{N} Ij \qquad ( 7 )$$

From the above, by sequentially calculating the formulae (6) (7) using IN, VN as initial values in the formulae (4) (5), it is possible to calculate the voltage drop generated in the mth pixel. Accordingly, to allow the given diode current, the data driver output voltage is corrected only by this value.

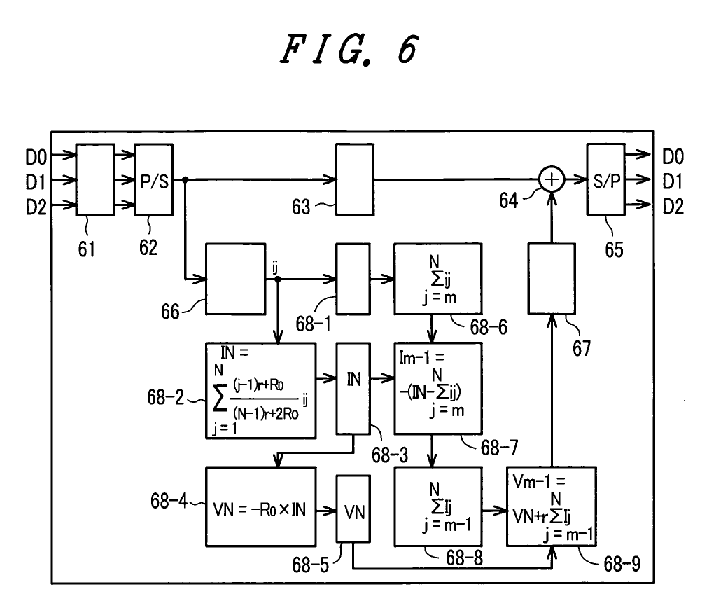

FIG. 6 shows the detail of a voltage drop correction circuit (1).

The voltage drop correction circuit (1) is incorporated in the inside of the display controller 8 shown in FIG. 1 and the corrected 3-output display data of n bits D0, D1, D2 are outputted to the modulation circuit 5.

Other portions of the display controller 8 receive video signals from the outside of the display device and output corrected 3-output display data of n bits D0, D1, D2 corresponding to red, green, blue to the voltage drop correction circuit (1), and control signals are outputted to the modulation circuit 5 and the scanning circuits 6-1, 6-2.

Numeral 61 indicates an inverse gamma processing part, numeral 62 indicates a P/S (parallel/serial) conversion circuit which converts the display data D0, D1, D2 corresponding to red, green, blue in conformity with the arrangement on the display panel 4, numeral 63 indicates a line memory which holds the display data which is converted into the serial data, numeral 64 indicates an adding circuit for adding the correction data, numeral 65 indicates a S/P (serial/parallel) conversion circuit for converting the corrected display data into the display data D0, D1, D2 corresponding to red, green, blue.

Numeral 66 indicates a data/current conversion circuit formed of a conversion table which converts the display data into the diode current, numerals 68-1 to 68-9 indicate correction voltage calculation means for calculating the correction voltages, and numeral 67 indicates a voltage/data conversion circuit for converting the correction voltage to the correction data.

Numeral 68-1 indicates a line memory which holds the diode current value ij of each pixel, numeral 68-2 indicates an IN calculation circuit which calculates a total current IN which flows from the ground point to the Nth pixel at the right end expressed by the formula (4) by multiplying the diode current values ij and coefficients of the respective pixels and by sequentially adding the multiplication values, numeral 68-3 indicates a current IN latch circuit which holds the calculated total current IN, numeral 68-4 indicates a voltage drop VN calculation circuit which obtains the voltage drop VN in the Nth pixel expressed by the formula (5) by multiplying the total current IN and the coefficient, numeral 68-5 indicates a voltage drop VN latch circuit which holds the calculated voltage drop VN, numeral 68-6 indicates a current ij adding circuit which sequentially adds the diode currents ij of the respective pixels among the line memory 68-1 from the Nth pixel, numeral 68-7 indicates a current Im−1 calculation circuit which obtains a current Im−1 which flows from the (m−1)th pixel to the mth pixel expressed by the formula (6) by subtracting the added value of the current ij adding circuit 68-6 from the total current IN held in the current IN latch circuit 68-3, numeral 68-8 indicates current Ij adding circuit which sequentially adds the currents Ij from the Nth pixel, numeral 68-9 indicates a Vm−1 calculation circuit which obtains the voltage drop Vm−1 generated in the (m−1)th pixel shown in the formula (7) by adding a value which is obtained by multiplying the scanning line resistance r per one pixel to the added value from the current Ij adding circuit 68-8 to the voltage drop VN held in the latch circuit 68-5.

Hereinafter, the manner of operation is explained. The 3-output display data of n bits D0, D1, D2 which correspond to red, green, blue and are inputted to the voltage drop correction circuit (1) are, after being subjected to the inverse gamma correction based on the relationship between the drive voltage and the light emitting characteristic of the display panel 4 in the inverse gamma processing part 61, converted into the serial data which conforms to the arrangement on the display panel 4 by the P/S conversion circuit 62, and is sequentially written in the line memory 63. In parallel with such an operation, the serial data is inputted to the data/current conversion part 66 and, after being converted into the diode current ij, the serial data is inputted to the correction voltage calculation means 68-1 to 68-9 and the correction voltages are calculated.

The diode currents ij are sequentially held in the line memory 68-1. On the other hand, in the IN calculation circuit 68-2, the total current IN which flows in the Nth pixel from the ground point which is expressed by the formula (4) by sequentially adding the multiplication of the diode current ij and the coefficient is calculated, and a value at a point of time that the sum of the Nth pixel is finished is held in the current IN latch circuit 68-3.

Further, in the voltage drop VN calculation circuit 68-4, the voltage drop VN in the Nth pixel expressed by the formula (5) is obtained from the holding total current value IN, and the voltage drop VN is held in the voltage drop VN latch circuit 68-5.

In the next horizontal period, in synchronism with sequential reading of the display data from the Nth pixel by the line memory 63, the voltage drop for correction is calculated and added. The voltage drop Vm−1 generated in the (m−1)th pixel is calculated in the following manner. The mth diode current im is read out from the line memory 68-1 and the current im is added to the sum of the diode currents from the Nth pixel to the (m+1)th pixel held in the inside of the current ij adding circuit 68-6.

The addition result is, in the current Im−1 calculation circuit 68-7,reduced from the current IN held in the current IN latch circuit 68-3,and a sign is inverted thus calculating the current Im−1 which flows into the mth pixel from the (m−1)th pixel expressed by the formula (6). The calculated current Im−1 is added to the sum of current from “the total current IN which flows in the ground point from the Nth pixel at the right end” to “the current Im which flows in the (m+1)th pixel from the mth pixel” held in the inside of the current Ij adding circuit 68-8.

The added value is inputted to the Vm−1 calculation circuit 68-9, the added value is multiplied with the scanning resistance r per one pixel, and the multiplication is added to the voltage drop VN held in the VN latch circuit 68-5 and hence, the voltage drop vm-1 generated in the (m−1)th pixel expressed by the formula (7) is obtained. The voltage drop Vm−1 is converted into the correction data by the voltage/data conversion circuit 67 and the correction data is added to the data held in the line memory 63 by the adding circuit 64.

Thereafter, the corrected display data is converted into the display data D0, D1, D2 corresponding to red, green, blue by the S/P conversion circuit 65.

In this embodiment, the total current IN which flows in the pixel at the right end portion from the ground point is obtained by the formula (4) by superposing the currents which flow from right among the diode currents of the respective pixels, and the resistance Ro from the ground point to the pixel at the right end portion is multiplied to the current IN so as to obtain the voltage drop VN in the pixel at the end portion based on the formula (5).

Then, the value obtained by sequentially adding the diode currents im from the pixel at the end portion to the mth pixel is subtracted from the total current IN thus obtaining the current Im−1 which flows in the mth pixel from the (m−1)th pixel based on the formula (6). Further, the sum of the voltage drop between the neighboring pixels which is obtained by multiplying the resistance value r per one pixel to the value which is obtained by sequentially adding the inter-neighboring-pixel current Im−1 from the end portion to the (m−1)th pixel is sequentially calculated from the voltage drop VN thus obtaining the voltage drop Vm−1 generated in the (m−1)th pixel based on the formula (7).

As a result, the sum of products operation within one horizontal scanning period becomes the N×N sum of products operation for calculating the current IN and the 1×1 accumulation operation N times for calculating the voltage drop Vm−1.

While the N×N sum of products operation is performed N times in the conventional method, in the invention, the sum of products operation can be drastically reduced to 1/N times and hence, the sum of products operation can be realized using the simple hardware.

### Embodiment 2

In the embodiment 1, the voltage drop Vm−1 is obtained based on the total current IN which flows in the ground point from the pixel at the right end and the voltage drop VN in the pixel at the right end.

In this embodiment, the voltage drop Vm+1 is sequentially obtained based on the current IO which flows in the pixel at the left end from the ground point and the voltage drop V1 in the pixel at the left end.

In FIG. 5, the current IO which flows in the first pixel at the left end from the ground point is expressed by a following formula (8) using the formula (2) based on the principle of superposition.

$$I 0 = {\sum }_{j = 1}^{N} iLj = {\sum }_{j = 1}^{N} \frac{( N - j ) r + {R}_{0}}{( N - 1 ) r + 2 {R}_{0}} ij \qquad ( 8 )$$

To multiply the resistance Ro from the ground point to the pixel at the left end to the current IO, the voltage drop V1 of the first pixel is obtained by a following formula (9).
V1=−R₀×I0 (9)

Further, in the same manner as the formula (8), the current Im which flows in the (m+1)th pixel from the mth pixel due to the current preservation law in the mth pixel is a value obtained by subtracting the diode current im of the mth pixel from the current Im−1 which flows in the mth pixel from the (m−1)th pixel. The similar relationship is established from the (m−1)th pixel to the first pixel and hence, a following formula (10) is established.

$$Im = Im - 1 - im = I 0 - {\sum }_{j = 1}^{m} ij \qquad ( 10 )$$

Further, the voltage drop Vm+1 which is generated in the (m+1)th pixel is a value which is obtained by subtracting the voltage drop rIm between the neighboring pixels to the Vm, wherein the voltage drop rIm is obtained by multiplying the resistance value r per one pixel to the current Im. The similar relationship is established from the (m−1)th pixel to the first pixel and hence, a following formula (11) is established.

$$Vm + 1 = Vm - rIm = V 1 - r {\sum }_{j = 1}^{m} Ij \qquad ( 11 )$$

From the above, by sequentially calculating the formulae (10) (11) using IO, V1 as initial values in the formulae (8) (9), it is possible to calculate the voltage drop generated in the mth pixel. Accordingly, to allow the given diode current to flow in the pixel, the data driver output voltage is corrected only by this value.

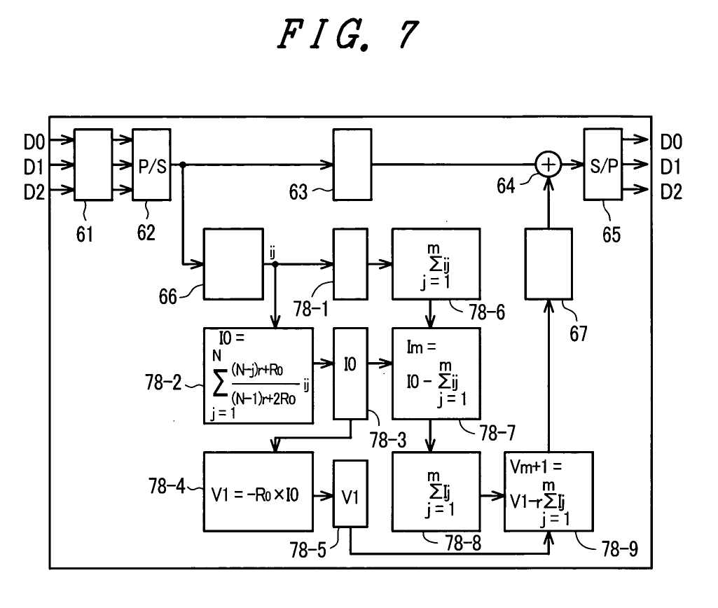

In FIG. 7, symbols 61 to 67 indicate parts identical with the parts shown in FIG. 6. Further, numerals 78-1 to 78-9 indicate correction voltage calculation means.

Numeral 78-1 indicates a line memory which holds the diode current value ij of each pixel, numeral 78-2 indicates an IO calculation circuit which calculates a total current IO which flows from the ground point to the first pixel at the left end expressed by the formula (8) by multiplying the diode current values ij of the respective pixels and the coefficient and by sequentially adding the multiplication values, numeral 78-3 indicates a current IO latch circuit which holds the calculated total current IO, numeral 78-4 indicates a voltage drop V1 calculation circuit which obtains the voltage drop V1 in the first pixel expressed by the formula (9) by multiplying the total current IO and the coefficient, numeral 78-5 indicates a voltage drop V1 latch circuit which holds the calculated voltage drop V1, numeral 78-6 indicates a current ij adding circuit which sequentially adds the diode currents ij of the respective pixels among the line memory 78-1 from the first pixel, numeral 78-7 indicates a current Im calculation circuit which obtains a current Im which flows from the first pixel to the mth pixel expressed by the formula (10) by subtracting the added value of the current ij adding circuit 78-6 from the current IO held in the current IO latch circuit 78-3, numeral 78-8 indicates current Ij adding circuit which sequentially adds the currents Ij from the first pixel, numeral 78-9 indicates a Vm+1 circuit calculation which obtains the voltage drop Vm+1 generated in the (m+1)th pixel shown in the formula (11) by subtracting a value which is obtained by multiplying the scanning line resistance r per one pixel to the added value from the current Ij adding circuit 78-8 to the voltage drop V1 held in the latch circuit 78-5.

Hereinafter, the manner of operation in FIG. 7 is explained. The diode currents ij are sequentially held in the line memory 78-1. On the other hand, in the IO calculation circuit 78-2, the total current IO which flows in the first pixel at the left end from the ground point which is expressed by the formula (8) by sequentially adding the multiplication of the diode current ij and the coefficient, and a value at a point of time that the sum of the Nth pixel is finished is held in the current IO latch circuit 78-3. The voltage drop V1 in the first pixel expressed by the formula (9) is obtained based on the held current value IO using the voltage drop V1 calculation circuit 78-4 and the voltage drop V1 is held in the voltage drop V1 latch circuit 78-5.

In the next horizontal period, the diode current ij held by the line memory 78-1 is sequentially read out from the first line memory 78-1 and the current ij is added in the current ij adding circuit 78-6. The added value is, in the current Im calculation circuit 78-7, reduced from the current IO held in the current IO latch circuit 78-3 thus calculating the current Im which flows into the (m+1)th pixel from the mth pixel expressed by the formula (10). The calculated current Im is added in the current Ij adding circuit 78-8.

The added value is inputted to the Vm+1 calculation circuit 78-9, the added value is multiplied with the scanning line resistance r per one pixel, and the multiplication is subtracted from the voltage drop V1 held in the V1 latch circuit 78-5 and hence, the voltage drop Vm+1 generated in the (m+1)th pixel expressed by the formula (11) is obtained.

In this embodiment, the total current IO which flows in the pixel at the left end portion from the ground point is obtained by the formula (8) by superposing the currents which flow to the left end among the diode currents of the respective pixels, and the resistance Ro from the ground point to the pixel at the left end portion is multiplied to the current IO so as to obtain the voltage drop V1 in the pixel at the end portion based on the formula (9).

Then, the value obtained by sequentially adding the diode currents im from the pixel at the end portion to the mth pixel is subtracted from the total current IO thus obtaining the current Im which flows in the (m+1)th pixel from the mth pixel based on the formula (10). Further, the sum of the voltage drop between the neighboring pixels which is obtained by multiplying the resistance value r per one pixel to the value which is obtained by sequentially adding the inter-neighboring-pixel current from the end portion to the mth pixel is sequentially calculated from the voltage drop V1 thus obtaining the voltage drop Vm+1 generated in the (m+1)th pixel based on the formula (11).

As a result, the sum of products operation within one horizontal scanning period becomes the N×N sum of products operation for calculating the current IO and the 1×1 accumulation operation N times for calculating the voltage drop Vm+1. Accordingly, while the N×N sum of products operation is performed N times in the conventional method, in the invention, the sum of products operation can be drastically reduced to 1/N times and hence, the sum of products operation can be realized using the simple hardware.

### Embodiment 3

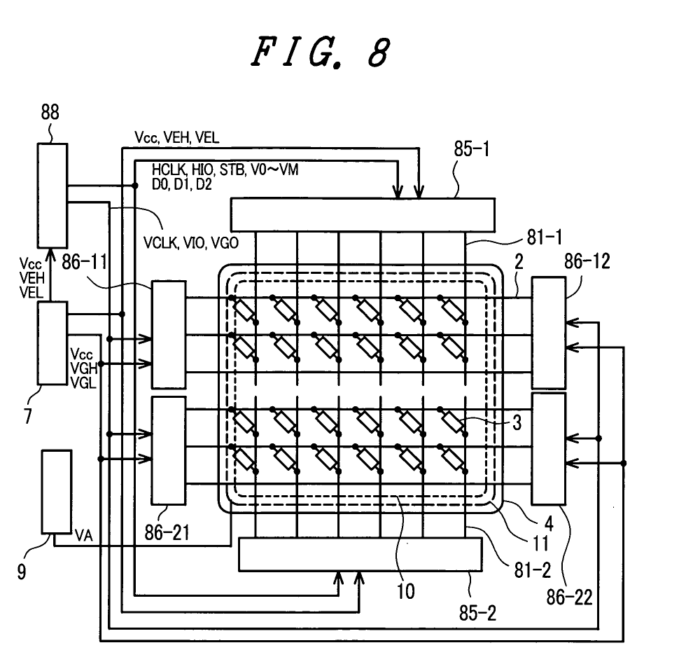

FIG. 8 is another whole constitutional view according to the invention, wherein the screen is divided into upper and lower blocks and images are simultaneously displayed on the upper and lower blocks.

In FIG. 8, symbols 2, 4, 7, 9, 10, 11 indicate parts identical with the parts shown in FIG. 1.

Numerals 81-1, 81-2 indicate column wirings which are divided at the center of the display panel 4, numerals 85-1, 85-2 indicate modulation circuits which respectively output modulation signals to the upper and lower wirings respectively, numerals 86-11, 86-12 indicate scanning circuits which are arranged on both sides of the display panel 4 and perform the row selection of the upper portion of the screen, and numerals 86-21, 86-22 indicate scanning circuits which are arranged on both sides of the display panel 4 and perform the row selection of the lower portion of the screen.

The driver power source 7 supplies a selection voltage VGH, a non-selection voltage VGL and a logic circuit voltage Vcc to the scanning circuits 86-11, 86-12, 86-21, 86-22. Further, the driver power source 7 supplies a light emitting voltage VEL, a non-light emitting voltage VEH, and a logic circuit voltage Vcc to the modulation circuits 85-1, 85-2 and the display controller 88.

The display controller 88 outputs a vertical clock VCLK, a start pulse VIO, a selection period signal VGO to the scanning circuits 86-11, 86-12, 86-21, 86-22, and supplies a horizontal clock HCLK, a start pulse HIO, an output changeover signal STB, the 3-output display data D0, D1, D2 corresponding to red, green, blue, n-bit and reference voltages V0 to VM to the modulation circuits 85-1, 85-2. Among these control signals, all signals except for the reference voltages V0 to VM have an amplitude of the logic circuit voltage Vcc. Here, corresponding to red, green, blue, 3-output display data D0, D1, D2 of n bits differ from each other between the modulation circuits 85-1, 85-2.

In FIG. 8, the constitution and the manner of operation of the modulation circuits 85-1, 85-2 and the constitution and the manner of operation of the scanning circuits 86-11, 86-12, 86-21, 86-22 are equal to those constitution and the manner of operation of the first embodiment.

Two voltage drop correction circuits shown in FIG. 6 or FIG. 7 are provided in the inside of the display controller 88, wherein the inputted 3-output display data D0, D1, D2 of n bits are simultaneously outputted to the respective modulation circuits 85-1, 85-2.

A frame memory is mounted in another portion of the display controller 88, receives the video signals from the outside of the display device, and outputs the 3-output display data D0, D1, D2 of n bits corresponding to red, green, blue to the voltage drop correction circuit corresponding to the upper and lower blocks. Further, the control signals are outputted to the modulation circuits 85-1, 85-2 and the scanning circuits 86-11, 86-12, 86-21, 86-22.

In this embodiment, since the screen is divided into the upper and lower blocks and the image is simultaneously displayed on the upper and lower blocks, the display time for one row can be increased twice compared to the related art. Accordingly, assuming that the brightness is equal, the current which flows in the row wiring can be halved and the voltage drop quantity to be corrected can be halved.

Further, since the column wirings are divided, the drive capacities of the modulation circuits 85-1, 85-2 can be halved, and the power which is consumed by the modulation circuits 85-1, 85-2 can be halved.

In the embodiments 1 to 3, when the resistances Ro from the pixels from the ground point to the end portion differ from each other with respect to the respective rows, the coefficients are calculated using resistances Ro which differ for every rows. Accordingly, it is possible to prevent the deterioration of image generated attributed to the non-uniformity of the resistances Ro.

What is claimed is:

1. A display device comprising:
a display panel having a back plate which includes a plurality of electron emission elements which are arranged on respective intersecting points of a plurality of row wirings and a plurality of column wirings, and a face plate which includes a metal back to which an anode voltage is applied and phosphors;
a scanning circuit which is formed on ends of the row wirings; and
a modulation circuit which gives display data to the column wirings, wherein the display device includes:
a total current calculation means which obtains a total current which flows into an end-portion pixel from a ground point at an end portion of the row wiring by superposing a component which flows in the pixel from the end portion side out of a current which flows in the column wiring from the row wiring of each pixel;
an end-portion pixel voltage drop calculation means which obtains a voltage drop in the end-portion pixel by multiplying resistance from the ground point to the end-portion pixel to the total current;
an inter-neighboring-pixel current calculation means which sequentially adds currents which flow from the row wiring to the column wiring in the pixels from the end-portion pixel to the mth pixel, and an added current is subtracted from the total current so as to obtain a current which flows between the neighboring pixels; and
a pixel voltage drop calculation means which obtains an summed value of the inter-neighboring pixel voltage drops by multiplying a resistance value per one pixel to a value which is obtained by sequentially adding the inter-neighboring pixel currents from the pixel of the end portion to the mth pixel and which obtains the voltage drops in the respective pixels by calculation based on the voltage drop in the end-portion pixel; and
by supplying the display data which is corrected based on an output value of the voltage drop calculation means to the column wirings, the voltage drop attributed to the current which flows into the row wirings from the scanning circuits is corrected.

2. A display device according to claim 1, wherein the column wirings are divided at the center of the display panel, a modulation circuit which supplies the display data to the divided column wirings and a scanning circuits which are arranged at both ends of the row wirings corresponding to the divided column wirings are provided, and images are simultaneously displayed on the display panel.

3. A display device comprising:
a display panel having a back plate which includes a plurality of electron emission elements which are arranged on respective intersecting points of a plurality of row wirings and a plurality of column wirings, and a face plate which includes a metal back to which an anode voltage is applied and phosphors;
scanning circuits which are formed on ends of the row wirings; and
a modulation circuit which gives display data to the column wirings, wherein the display device includes:
a correction voltage calculation means which calculates a correction voltage for correcting the display data such that voltage drops generated in respective row wiring portions which are determined in response to image data to be displayed are compensated, and
a resistance value between a ground point for calculating a correction voltage and the pixel at an end portion of the row wiring differs for every row.
